(19) United States
(12) Patent Application Publication
(10) Pub. No.: US 2020/0039467 A1
(43) Pub. Date: Feb. 6, 2020

(54) PEDESTRIAN PROTECTION SYSTEM

(71) Applicant: HONDA MOTOR CO., LTD., Tokyo (JP)

(72) Inventors: Osamu ITO, Wako-shi (JP); Masaki UMEZAWA, Wako-shi (JP); Hiroyuki ASANUMA, Wako-shi (JP); Yasuaki GUNJI, Wako-shi (JP)

(21) Appl. No.: 16/527,929

(22) Filed: Jul. 31, 2019

(30) Foreign Application Priority Data
Aug. 3, 2018 (JP) 2018-146569

(51) Int. Cl. B60R 21/38; B60R 21/00; B60R 21/01; B60R 21/0134

(52) U.S. Cl. CPC B60R 21/38; B60R 21/00; B60R 21/01; B60R 2021/01286; B60R 2021/0048; B60R 2021/01252; B60R 21/0134

(57) ABSTRACT

A pedestrian protection system includes: a hood pop-up device that drives a bonnet hood of the vehicle such that a position of the bonnet hood is popped up; an information acquisition part part configured to acquire target object information containing information on one or more pedestrians present in a travel direction of the vehicle; a collision prediction part part configured to determine a pedestrian who is predicted to collide with the vehicle, based on the target object information acquired by the information acquisition part; and a drive control part part configured to control driving of the hood pop-up device such that the bonnet hood is positioned to cushion impact on a head of the pedestrian determined by the collision prediction part. The bonnet hood is positioned on a slant with respect to a right and left direction of the vehicle.

### CROSS REFERENCE TO RELATED APPLICATION

This application claims the benefit of Japanese Patent Application No. 2018-146569 filed on Aug. 3, 2018, the disclosure of which is incorporated herein by reference.

### BACKGROUND OF THE INVENTION

### 1. Field of the Invention

The present invention relates to a pedestrian protection system which can protect a pedestrian with which a vehicle equipped with the pedestrian protection system has collided.

### 2. Description of the Related Art

When a front bumper of a car collides with a pedestrian (a primary collision), in some cases, the pedestrian falls toward a bonnet hood of the car, and a head, for example, of the pedestrian further collides with a body of the car (a secondary collision).

In order to cushion impact on a head or the like of a pedestrian who is involved in such a collision, for example, Japanese Laid-Open Patent Application, Publication No. 2012-111339 (to be referred to as Patent Document 1 hereinafter) discloses a device in which: in a collision of a car with a pedestrian, when the car of interest estimates a physical constitution of the pedestrian involved in the collision, and if the car acquires an estimate result that the pedestrian is an adult, a rear end portion of a bonnet hood of the car is popped up so as to suitably cushion impact on a head of the pedestrian.

[Patent Document 1] Japanese Laid-Open Patent Application, Publication No. 2012-111339

### SUMMARY OF THE INVENTION

When a pedestrian who has collided with a car falls toward a bonnet hood of the car, behavior of the pedestrian greatly differs depending on a physical constitution including a body height of the pedestrian, a relative attitude or a relative speed between the car and the pedestrian, or the like. When the pedestrian who has collided with a car falls toward the bonnet hood and a head of the pedestrian is directed to either a right or a left portion of the bonnet hood, there is a risk that just popping-up of a rear end of the bonnet hood of the car at a timing at which the car collides with the pedestrian cannot cushion impact on the head of the pedestrian.

In light of the problem described above, the present invention has been made in an attempt to provide a pedestrian protection system in which, even when a pedestrian who has collided with a car falls toward a bonnet hood of the car and a head of the pedestrian is then directed to either a right or a left portion of the bonnet hood, the pedestrian can be protected by suitably cushioning impact on the head of the pedestrian.

A pedestrian protection system includes: a hood pop-up device that drives a bonnet hood of the vehicle such that a position of the bonnet hood is popped up; an information acquisition part part configured to acquire target object information containing information on one or more pedestrians present in a travel direction of the vehicle; a collision prediction part part configured to determine a pedestrian who is predicted to collide with the vehicle, based on the target object information acquired by the information acquisition part; and a drive control part part configured to control driving of the hood pop-up device such that the bonnet hood is positioned to cushion impact on a head of the pedestrian determined by the collision prediction part. The bonnet hood is positioned on a slant with respect to a right and left direction of the vehicle.

The pedestrian protection system of the present invention can protect a pedestrian by suitably cushioning impact on the head of the pedestrian, even when the pedestrian who has collided with a car falls toward a bonnet hood of the car and a head of the pedestrian is then directed to either a right or a left portion of the bonnet hood.

### BRIEF DESCRIPTION OF THE DRAWINGS

FIG. 1 is a block diagram illustrating an outline of a pedestrian protection system according to an embodiment of the present invention.

FIG. 2 is a diagram illustrating a schematic block diagram illustrating a hood pop-up device and its surrounding portion which constitutes a main part of the pedestrian protection system according to the embodiment of the present invention.

FIG. 3 is a flowchart illustrating operations of the pedestrian protection system according to the embodiment of the present invention.

FIG. 4A is an explanatory diagram illustrating operations of the pedestrian protection system according to the embodiment of the present invention.

FIG. 4B is another explanatory diagram illustrating the operations of the pedestrian protection system according to the embodiment of the present invention.

FIG. 4C is a still another explanatory diagram illustrating the operations of the pedestrian protection system according to the embodiment of the present invention.

FIG. 5A is a diagram illustrating an explanatory diagram illustrating operations of a pedestrian protection system according to a variation of the present invention.

FIG. 5B is another explanatory diagram illustrating the operations of the pedestrian protection system according to the variation of the present invention.

FIG. 5C is a still another explanatory diagram illustrating the operations of the pedestrian protection system according to the variation of the present invention.

### DESCRIPTION OF THE EMBODIMENTS

A pedestrian protection system according to an embodiment of the present invention is described next in detail with reference to the related drawings.

The same reference numerals are basically assigned to respective members having the same or mutually corresponding functions in the drawings to be shown below. For convenience of explanation, a size or a shape of a member are deformed or exaggerated and are schematically illustrated in some cases.

### [Outline of Pedestrian Protection System 11]

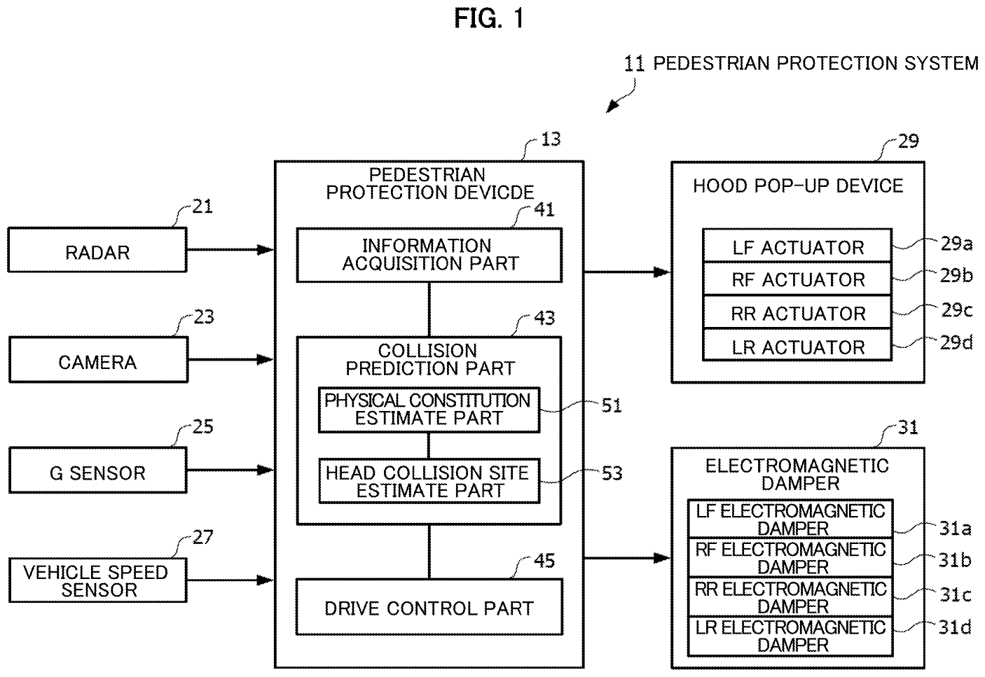

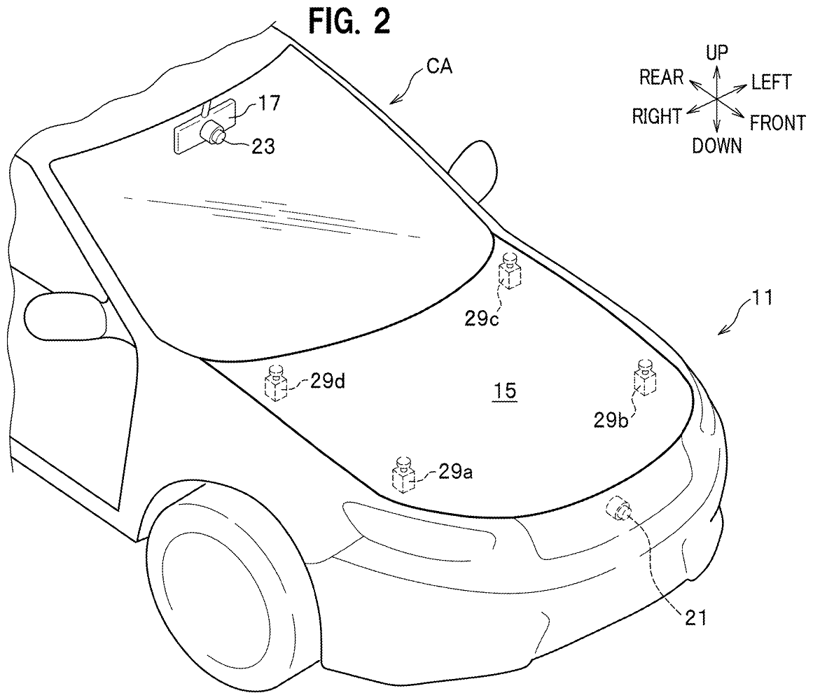

Outline of a pedestrian protection system 11 according to an embodiment of the present invention is described with reference to FIG. 1 and FIG. 2 where appropriate.

FIG. 1 is a block diagram illustrating an outline of the pedestrian protection system 11 according to the embodiment of the present invention. FIG. 2 is a schematic block diagram illustrating a hood pop-up device 29 and its surrounding portion which constitutes a main part of the pedestrian protection system 11 according to the embodiment of the present invention.

The pedestrian protection system 11 according to the embodiment of the present invention includes, as illustrated in FIG. 1, a pedestrian protection device 13 installed in a car of interest CA (see FIG. 2) in which the pedestrian protection system 11 is provided.

The pedestrian protection device 13: monitors whether one or more pedestrians MA are present in a moving direction of the car CA; when the car CA is predicted to collide with any one of the pedestrians MA (who may be referred to as a particular pedestrian MA) estimates a physical constitution of the particular pedestrian MA and a portion onto which a head of the pedestrian collides with the car CA; and controls, based on the estimated results, driving of the hood pop-up device 29 such that the bonnet hood 15 (see FIG. 2) is positioned to cushion impact on the head of the pedestrian MA.

When the car CA is predicted to collide with the particular pedestrian MA, the hood pop-up device 29 instantly makes the bonnet hood 15 popped up. This makes it possible to cushion impact on the head of the particular pedestrian MA with which the car CA has collided.

Generally, in-vehicle components (not illustrated) such as an engine, a battery, and a radiator are disposed under the bonnet hood 15, which are made of hard material and may give damage to a human body in case of collision.

Thus, when the car CA is predicted to collide with the particular pedestrian MA, the hood pop-up device 29 instantly makes the bonnet hood 15 popped up. This makes it possible to create a buffer space between the bonnet hood 15 and the in-vehicle components and therefore cushion impact on the head of the pedestrian MA with which the car CA has collided.

The pedestrian protection device 13 is connected to each of a radar 21, a camera 23, a G sensor 25, and a vehicle speed sensor 27, each of which serves an input system.

The radar 21 used herein where appropriate includes, for example, a laser radar, a microwave radar, a millimeter-wave radar, and an ultrasonic radar. The radar 21 is installed at, for example, a back side of a front grille of the car CA, as illustrated in FIG. 2. The radar 21 detects a distribution of target objects present in a direction in which the car CA travels. Information on the target object distribution is transmitted to the pedestrian protection device 13.

The camera 23 has an optical axis which is slanted downward in front of the car CA and takes an image in the direction in which the car CA travels. The camera 23 suitably used herein includes, for example, a CMOS (Complementary Metal Oxide Semiconductor) camera and a CCD (Charge Coupled Device) camera. The camera 23 is installed, for example, on a back surface of a rearview mirror 17 disposed at an upper central part of a windshield of the car CA, as illustrated in FIG. 2.

Information on image in the traveling direction of the car CA taken by the camera 23 is transmitted to the pedestrian protection device 13, as image information created by interlace such as a NTSC (National Television Standards Committee).

The G sensor 25 detects back-and-forth G (back-and-forth acceleration/deceleration) and lateral G (lateral acceleration/deceleration) generated in the car CA. Information on the G detected by the G sensor 25 is transmitted to the pedestrian protection device 13.

The vehicle speed sensor 27 detects a vehicle speed of the car CA. Information on the vehicle speed detected by the vehicle speed sensor 27 is transmitted to the pedestrian protection device 13.

The pedestrian protection device 13 is connected to, as illustrated in FIG. 1, each of the hood pop-up device 29 and an electromagnetic damper 31, each of which serves as an output system.

In order to support four corners of the substantially square-shaped bonnet hood 15 from below in a freely advancing and retracting manner, the hood pop-up device 29 includes a LF actuator 29a, a RF actuator 29b, a RR actuator 29c, and a LR actuator 29d, which are disposed at respective appropriate positions near the four corners. For example, the LF actuator 29a has one end thereof disposed on a side nearer to a body of the car CA and the other end disposed below one of the four corners of the bonnet hood 15. Each of the other actuators 29b-29d is structured similarly to the LF actuator 29a.

The LF actuator 29a, the RF actuator 29b, the RR actuator 29c, and the LR actuator 29d are driven separately from each other in a freely advancing and retracting manner.

The electromagnetic damper 31 generates vibration damping force of the car body and adjusts a height of the car CA. The electromagnetic damper 31 includes a LF electromagnetic damper 31a, a RF electromagnetic damper 31b, a RR electromagnetic damper 31c, and a LR electromagnetic damper 31d, which are disposed in parallel with respective spring members (not illustrated) interposed between the body of the car CA and respective four wheels. For example, the LF electromagnetic damper 31a has one end thereof disposed on a side nearer to the body of the car CA and the other end disposed on a side nearer to the wheels. Each of the other electromagnetic dampers 31b to 31d is structured similarly to the LF electromagnetic damper 31a.

The LF electromagnetic damper 31a, the RF electromagnetic damper 31b, the RR electromagnetic damper 31c, and the LR electromagnetic damper 31d are driven separately from each other in a freely advancing and retracting manner.

The pedestrian protection device 13 includes, as illustrated in FIG. 1, an information acquisition part 41, a collision prediction part 43, and a drive control part 45.

The information acquisition part 41 acquires: the target object distribution information in the travel direction of the car CA of interest detected by the radar 21; the image information in the travel direction of the car CA taken by the camera 23; the G information detected by the G sensor 25; and the vehicle speed information detected by the vehicle speed sensor 27.

The collision prediction part 43 detects a collision of a target object with the car CA (a primary collision), based on the G information acquired by the information acquisition part 41.

More specifically, the collision prediction part 43: determines that the primary collision has occurred, when an output value acquired based on the G information exceeds a collision determination threshold as a reference value for determining whether or not the target object collides with the car CA; and transmits primary collision detection information which is information indicating that the primary collision of the car CA has occurred, to the drive control part 45.

Also, the collision prediction part 43 also determines one or more pedestrians MA each of who is predicted to collide with the car CA, based on the target object information (including image information) in the travel direction of the car CA acquired by the information acquisition part 41.

More specifically, the collision prediction part 43: sequentially performs an outline extraction processing and a patter matching processing to the target object information (includes the image information) in the travel direction thereof; and thereby determines whether or not the pedestrian MA is present in the travel direction.

If it is determined that one or more pedestrians MA are present in the travel direction of the car CA, the collision prediction part 43 estimates a relative distance between the car CA and the pedestrian MA having been captured as being present in the travel direction, based on a position and a size of the captured pedestrian MA.

The collision prediction part 43 tracks the captured pedestrian MA using any known object tracking technique. The collision prediction part 43 thereby estimates a relative travel direction and a relative travel speed of the captured pedestrian MA, based on a degree of change in the position or size of the captured pedestrian MA in a plurality of successive frames.

The collision prediction part 43 then estimates a relative speed between the car CA and the captured pedestrian MA, based on the estimated result of the relative travel direction and travel speed of the captured pedestrian MA.

The collision prediction part 43 then performs a collision prediction determination which is a determination on whether or not the car CA is predicted to collide with a particular pedestrian MA among the one or more captured pedestrians MA, based on the estimated result of the relative distance and relative speed between the car CA and the captured pedestrian MA. The collision prediction part 43 also estimates a collision remaining time TTC which is a time left before the car CA collides with the particular pedestrian MA.

The collision prediction part 43 includes a physical constitution estimate part 51 that estimates a physical constitution including a body height of the particular pedestrian MA. The physical constitution estimate part 51 estimates the physical constitution including the body height of the particular pedestrian MA, by analyzing the image information on the particular pedestrian MA taken by the camera 23.

The collision prediction part 43 also includes a head collision site estimate part 53 that estimates a site of a head of the particular pedestrian MA against which the car CA is predicted to collide. The head collision site estimate part 53 estimates the head site of the particular pedestrian MA against which the car CA is predicted to collide, by analyzing the image information on the particular pedestrian MA taken by the camera 23, similarly to the estimate of the physical constitution performed by the physical constitution estimate part 51.

When the collision prediction determination showing that the car CA is predicted to collide with the particular pedestrian MA is made, the collision prediction part 43 transmits the collision prediction information to the drive control part 45. The collision prediction information contains: the collision remaining time TTC which is a remaining time before the car CA is predicted to collide with the particular pedestrian MA; an estimated result of the physical constitution including the body height of the particular pedestrian MA; and an estimated result of the head site of the particular pedestrian MA with which the car CA is predicted to collide.

Upon receipt of the collision prediction information, the drive control part 45 controls driving of the hood pop-up device 29 such that the bonnet hood 15 is positioned to cushion impact on the head of the particular pedestrian MA, based on the received collision prediction information.

Upon receipt of the collision prediction information, the drive control part 45 controls driving of the electromagnetic damper 31 such that the car CA is positioned to cushion impact on the head of the particular pedestrian MA, based on the received collision prediction information.

The drive control part 45 performs the drive control of the hood pop-up device 29 and that of the electromagnetic damper 31 in coordination with each other.

More specifically, for example, in order that the bonnet hood 15 is suitably positioned, the drive control part 45 mainly controls driving of the hood pop-up device 29, and, where necessary, the drive control part 45 auxiliarily controls driving of the electromagnetic damper 31.

The pedestrian protection device 13 is embodied by a microcomputer made up of a CPU (Central Processing Unit), a ROM (Read Only Memory), a RAM (Random Access Memory), or the like. The microcomputer loads and executes a program or data stored in the ROM, and operates to perform execution control of various functions of the pedestrian protection device 13, such as: information acquisition functions of various types; collision prediction functions including the physical constitution estimate and the head collision site estimate; and drive control functions of the hood pop-up device 29 and the electromagnetic damper 31.

### [Operations of Pedestrian Protection System 11]

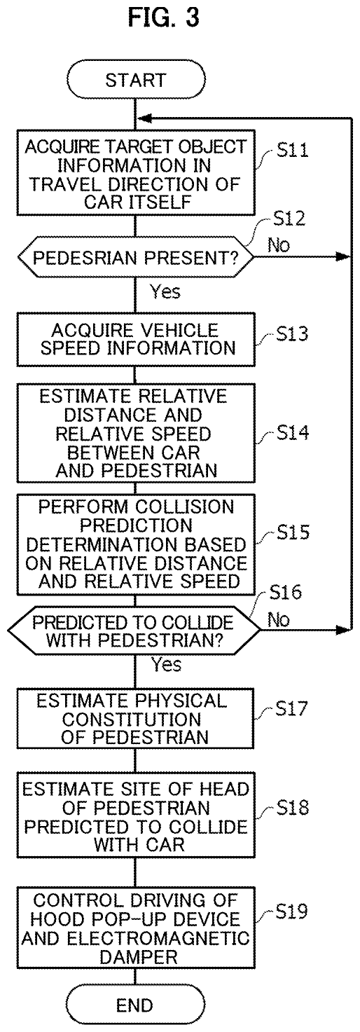

Next are described operations of the pedestrian protection system 11 according to an embodiment of the present invention with reference to FIG. 3. FIG. 3 is a flowchart for explaining the operations of the pedestrian protection system 11 according to the embodiment of the present invention.

In step S11 illustrated in FIG. 3, the information acquisition part 41 of the pedestrian protection device 13 acquires: the target object distribution information in the travel direction of the car CA detected by the radar 21; and the target object information in the travel direction including image information therein taken by the camera 23.

In step S12, the collision prediction part 43 of the pedestrian protection device 13 sequentially performs an outline extraction processing and a pattern matching processing to the target object information in the travel direction of the car CA, acquired by the information acquisition part 41; and thereby determines whether or not the pedestrian MA is present in the travel direction thereof.

If it is determined as a result of the determination made in step S12 that the pedestrian MA is not present in the travel direction of the car CA, the pedestrian protection device 13 returns the processing flow to step S11.

If it is determined as the result of the determination made in step S12 that, on the other hand, the pedestrian MA is present in the travel direction thereof, the pedestrian protection device 13 advances the processing flow to subsequent step S13.

In step S13, the information acquisition part 41 of the pedestrian protection device 13 acquires the vehicle speed information detected by the vehicle speed sensor 27.

In step S14, the collision prediction part 43 of the pedestrian protection device 13 estimates a relative distance between the car CA and the captured pedestrian MA, based on a position and a size of the captured pedestrian MA who is present in the travel direction of the car CA.

The collision prediction part 43 tracks the captured pedestrian MA using any known object tracking technique. The collision prediction part 43 thereby estimates a relative travel direction and a relative travel speed of the captured pedestrian MA, based on a degree of change in the position or size of the captured pedestrian MA in a plurality of successive frames.

The collision prediction part 43 then estimates a relative speed between the car CA and the captured pedestrian MA, based on the estimated result of the relative travel direction and travel speed of the captured pedestrian MA.

In steps S15 to S16, the collision prediction part 43 of the pedestrian protection device 13 performs a collision prediction determination which is a determination on whether or not the car CA is predicted to collide with the particular pedestrian MA from among the one or more captured pedestrians MA, based on the estimated result of the relative distance and relative speed between the car CA and the captured pedestrian MA. The collision prediction part 43 also estimates the collision remaining time TTC which is a time left before the car CA is predicted to collide with the particular pedestrian MA.

If it is determined as a result of the collision prediction determination in step S16 that the car CA is not predicted to collide with the particular pedestrian MA, the pedestrian protection device 13 returns the processing flow to step S11.

If it is determined as the result of the collision prediction determination in step S16 that, on the other hand, the car CA is predicted to collide with the particular pedestrian MA, the pedestrian protection device 13 advances the processing flow to step S17.

In step S17, the physical constitution estimate part 51 of the collision prediction part 43 of the pedestrian protection device 13 estimates a physical constitution including a body height of the particular pedestrian MA.

In step S18, the head collision site estimate part 53 of the collision prediction part 43 of the pedestrian protection device 13 estimates a site of a head of the particular pedestrian MA with which the car CA is predicted to collide.

The estimated results oft the collision remaining time TTC in step S15; the physical constitution of the particular pedestrian MA including the body height thereof in steps S17 to S18; and the head site of the particular pedestrian MA with which the car CA is predicted to collide, are transmitted to the drive control part 45 as the collision prediction information.

In step S19, upon receipt of the collision prediction information, the drive control part 45 controls driving of the hood pop-up device 29 such that the bonnet hood 15 is positioned to cushion impact on the head of the particular pedestrian MA, based on the received collision prediction information.

Upon receipt of the collision prediction information, the drive control part 45 also controls driving of the electromagnetic damper 31 where necessary, such that the car CA is positioned to cushion impact on the head of the particular pedestrian MA, based on the received collision prediction information.

### [Advantageous Effects of Pedestrian Protection System 11]

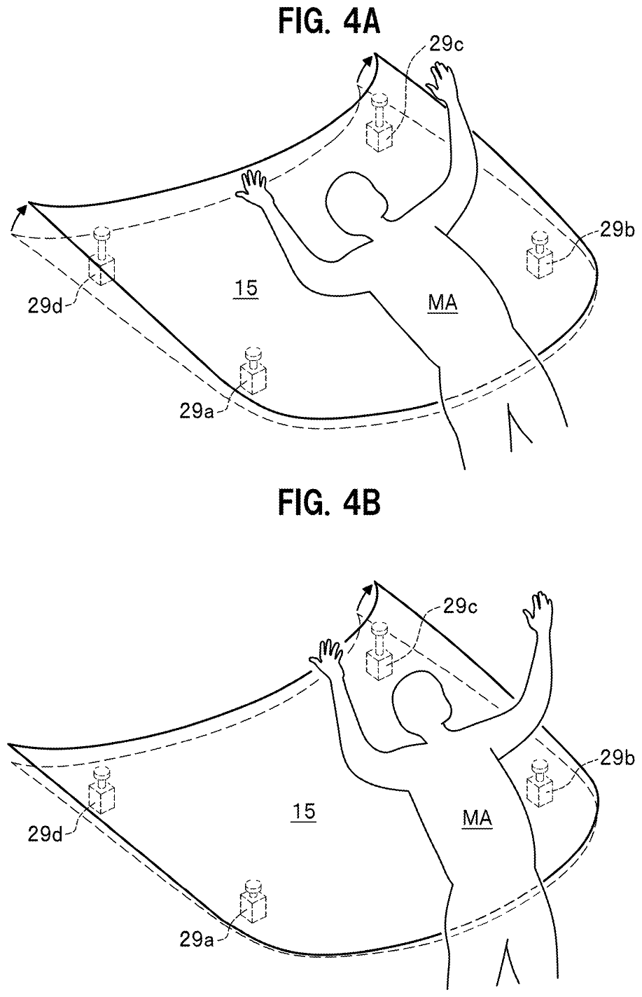

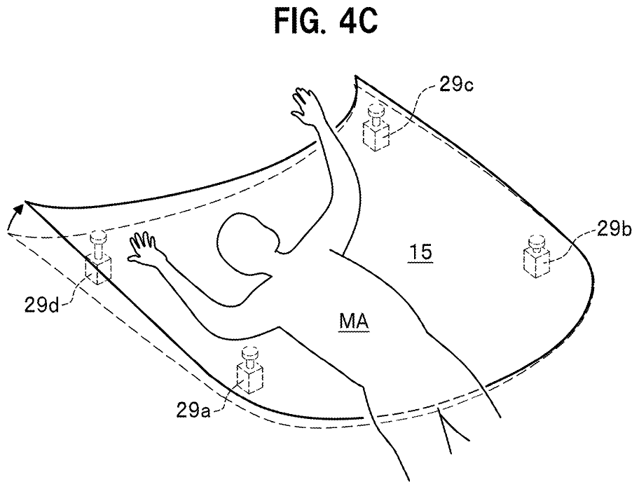

Next are described advantageous effects of the pedestrian protection system 11 according to the embodiment of the present invention with reference to FIG. 4A to FIG. 4C. FIG. 4A to FIG. 4C are each an explanatory diagram illustrating operations of the pedestrian protection system 11.

In one aspect of the present invention, the pedestrian protection system 11 includes: the hood pop-up device 29 that drives the bonnet hood 15 of the car CA such that a position of the bonnet hood 15 is popped up; the information acquisition part 41 that acquires the target object information including information on the one or more pedestrians MA each of who is present in the travel direction of the car CA; the collision prediction part 43 that determines the pedestrian MA with which the car CA is predicted to collide, based on the target object information acquired by the information acquisition part 41; and the drive control part 45 that controls driving of the hood pop-up device 29 such that the bonnet hood 15 is positioned to cushion impact on the head of the pedestrian MA who the collision prediction part 43 has determined to collide with the car CA. The bonnet hood 15 is herein structured to be positioned on a slant with respect to the right and left direction of the car CA.

In the pedestrian protection system 11 in the one aspect, the drive control part 45 controls driving of the hood pop-up device 29 such that the bonnet hood 15 is positioned to cushion impact on the head of the pedestrian MA who the collision prediction part 43 has determined to collide with the car CA. The drive control performed by the drive control part 45 makes the bonnet hood 15 positioned on a slant with respect to the right and left direction of the car CA.

The following three cases are assumed in the pedestrian protection system 11 according to the embodiment of the present invention, as a behavior taken by the pedestrian MA who has collided with the car CA and then falls toward the bonnet hood 15 of the car CA.

Namely, case 1 in which the pedestrian MA falls toward a central portion of the car CA in the right and left direction (a direction of a width of the car CA); case 2 in which the pedestrian MA falls toward a right side portion (when viewed from a front side) of the car CA in the right and left direction (the direction of the width of the car CA); and case 3 in which the pedestrian MA falls toward a left side portion (when viewed from the front side) of the car CA in the right and left direction (the direction of the width of the car CA).

In case 1, as illustrated in FIG. 4A, while keeping extendable states of the LF actuator 29a and the RF actuator 29b of the hood pop-up device 29 as they are, each of which is disposed on the front side of the car CA, the pedestrian protection system 11 drives extendable states of the RR actuator 29c and the LR actuator 29d, each of which is disposed on a rear side of the car CA, in an advancing direction. This makes the bonnet hood 15 to be positioned with the rear side thereof popped up.

In case 1 in which the pedestrian MA falls toward the central portion of the bonnet hood 15 in the right and left direction (the vehicle width direction) of the car CA, the bonnet hood 15 is positioned with the rear side thereof popped up. Then, as illustrated in FIG. 4A, a head of the pedestrian MA which has fallen onto the central portion of the car CA in the right and left direction (the vehicle width direction) bumps into the popped-up bonnet hood 15 such that the bonnet hood 15 supports the head.

Thus, in case 1, the pedestrian can be protected by appropriately cushioning impact on the head of the pedestrian MA with which the car CA has collided.

In case 2 in which the pedestrian MA falls toward the right portion of the bonnet hood 15 in the right and left direction of the car CA (the vehicle width direction) (when viewed from the front side of the car CA), as illustrated in FIG. 4B, while keeping the extendable state of the LF actuator 29a disposed on a front left side of the hood pop-up device 29 of the car CA, the pedestrian protection system 11 mainly drives an extendable state of the RR actuator 29c disposed on a right rear side of the car CA in an advancing direction. This makes the bonnet hood 15 positioned with a right rear portion thereof popped up.

In case 2, the bonnet hood 15 is positioned with a right rear side thereof of the car CA popped up. Then, as illustrated in FIG. 4B, a head of the pedestrian MA which has fallen onto the right portion of the car CA in the right and left direction (the vehicle width direction) bumps into the slanted bonnet hood 15 with the right rear side thereof in the right and left direction of the car CA popped up, such that the bonnet hood 15 supports the head.

Thus, in case 2, the pedestrian can also be protected by appropriately cushioning impact on the head of the pedestrian MA with which the car CA has collided.

In case 2 in which the pedestrian MA falls toward the right portion of the bonnet hood 15 in the right and left direction of the car CA (the vehicle width direction) (when viewed from the front side of the car CA), as illustrated in FIG. 4B, while keeping the extendable state of the LF actuator 29a disposed on the front left side of the hood pop-up device 29 of the car CA, the pedestrian protection system 11 mainly drives the extendable state of the RR actuator 29c disposed on the right rear side of the car CA in the advancing direction. This makes the bonnet hood 15 positioned with the right rear portion thereof popped up.

In case 3 in which the pedestrian MA falls toward the left portion of the bonnet hood 15 in the right and left direction of the car CA (the vehicle width direction) (when viewed from the front side of the car CA), as illustrated in FIG. 4C, while keeping an extendable state of the LF actuator 29b disposed on a front right side of the hood pop-up device 29 of the car CA, the pedestrian protection system 11 mainly drives an extendable state of the LR actuator 29d disposed on a left rear side of the car CA in an advancing direction. This makes the bonnet hood 15 positioned with a left rear portion thereof popped up.

In case 3, the bonnet hood 15 is positioned with the left rear side thereof popped up. Then, as illustrated in FIG. 4C, the head of the pedestrian MA which has fallen onto the left portion of the car CA in the right and left direction (the vehicle width direction) bumps into the slanted bonnet hood 15 with the left rear side thereof in the right and left direction of the car CA popped up, such that the bonnet hood 15 supports the head.

Thus, in case 3, the pedestrian can also be protected by appropriately cushioning impact on the head of the pedestrian MA with which the car CA has collided.

In the pedestrian protection system 11 in the one aspect, when the car CA has collided with the pedestrian MA, the drive control part 45 controls driving of the bonnet hood 15 such that the bonnet hood 15 is positioned on a slant with respect to the right and left direction of the car CA. Thus, even when the head of the pedestrian MA with who the car CA has collided is directed to either the right or left side of the bonnet hood 15, the pedestrian can be protected by appropriately cushioning impact on the head of the pedestrian MA.

In the pedestrian protection system 11 in another aspect of the present invention: the pedestrian protection system 11 in the one aspect further includes the electromagnetic damper (which may also be referred to as variable damper) 31 which drives the car CA such that attitude of the car CA is changed up, down, right, or left; and the drive control part 45 controls driving of the electromagnetic dampers 31 such that the car CA is positioned at an attitude at which impact on the head of the pedestrian MA determined by the collision prediction part 43 is cushioned.

In the pedestrian protection system 11 in another aspect, in addition to the drive control of the hood pop-up device 29, the drive control part 45 controls driving of the electromagnetic damper 31 such that the car CA is positioned at an attitude at which impact on the head of the pedestrian MA determined by the collision prediction part 43 is cushioned. Thus, the pedestrian protection system 11 in another aspect can further improve the effect of protecting the pedestrian MA by cushioning impact on the head of the pedestrian MA, compared to the pedestrian protection system 11 in the one aspect.

In a still another aspect of the present invention: the pedestrian protection system 11 is the pedestrian protection system 11 in the one aspect; the collision prediction part 43 includes the physical constitution estimate part 51 that estimates a physical constitution of the pedestrian MA determined by the collision prediction part 43, and the head collision site estimate part 53 that estimates a site of a head of the pedestrian MA determined by the collision prediction part 43, with which the car CA has collided; and the drive control part 45 controls driving of the hood pop-up device 29 such that the bonnet hood 15 is positioned to cushion impact on the head of the particular pedestrian MA, based on the estimated results of the physical constitution of the particular pedestrian MA by the physical constitution estimate part 51 and the head collision site of the particular pedestrian MA by the head collision site estimate part 53.

In the pedestrian protection system 11 in the still another aspect, the drive control part 45 controls driving of the hood pop-up device 29 such that the bonnet hood 15 is positioned to cushion impact on the head of the particular pedestrian MA, based on the estimated results of the physical constitution of the particular pedestrian MA by the physical constitution estimate part 51 and the head collision site of the particular pedestrian MA by the head collision site estimate part 53. Thus, the pedestrian protection system 11 in the still another aspect can further improve the effect of protecting the pedestrian MA by cushioning impact on the head of the pedestrian MA, compared to the pedestrian protection system 11 in the one aspect.

In a yet another aspect of the present invention: the pedestrian protection system 11 is the pedestrian protection system 11 in another aspect; the collision prediction part 43 includes the physical constitution estimate part 51 that estimates a physical constitution of the pedestrian MA determined by the collision prediction part 43, and the head collision site estimate part 53 that estimates a site of a head of the pedestrian MA determined by the collision prediction part 43, with which the car CA has collided; and the drive control part 45 controls driving of the electromagnetic dampers (variable dampers) 31 such that the car CA is positioned to cushion impact on the head of the particular pedestrian MA, based on the estimated results of the physical constitution of the particular pedestrian MA by the physical constitution estimate part 51 and the head collision site of the particular pedestrian MA by the head collision site estimate part 53.

In the pedestrian protection system 11 in the yet another aspect, let us assume a case where, for example, such an estimated result is acquired that a body height of the particular pedestrian MA determined by the physical constitution estimate part 51 is larger than average as the physical constitution. The drive control part 45 then controls driving of the electromagnetic damper (variable damper) 31 such that a height of the car CA becomes larger than that when another estimated result is acquired that the body height of the particular pedestrian MA is on average, using the electromagnetic damper 31 (the LF electromagnetic damper 31a and the RF electromagnetic damper 31b) disposed in the front portion of the car CA.

With the structure described above, the head of the pedestrian MA with which the car CA has collided is made to bump into the bonnet hood 15 which has buffer space. Thus, the effect of protecting the pedestrian MA by cushioning impact on the head thereof can be expected.

In the pedestrian protection system 11 in the yet another aspect, the drive control part 45 controls driving of the electromagnetic damper (variable damper) 31 such that the car CA is positioned to cushion impact on the head of the particular pedestrian MA, based on the estimated results of the physical constitution of the particular pedestrian MA by the physical constitution estimate part 51 and the head collision site of the particular pedestrian MA by the head collision site estimate part 53. Thus, the pedestrian protection system 11 in the still another aspect can further improve the effect of protecting the pedestrian MA by cushioning impact on the head of the pedestrian MA, compared to the pedestrian protection system 11 in another aspect.

### Other Embodiments

The above-explained embodiments are given as examples for realizing the present invention. Thus, the embodiments should not be interpreted as limitation of the technical scope of the present invention. The present invention can be implemented in various modes without departing from its gist or key features.

For example, explanation of the pedestrian protection system 11 according to the embodiment of the present invention has been made by exemplifying the hood pop-up device 29 of four-point support type in which, in order to support four corners (four points) of the substantially square-shaped bonnet hood 15 from below in a freely advancing and retracting manner, the LF actuator 29a, the RF actuator 29b, the RR actuator 29c, and the LR actuator 29d are disposed at respective appropriate positions near the four corners. The present invention is not, however, limited to the example.

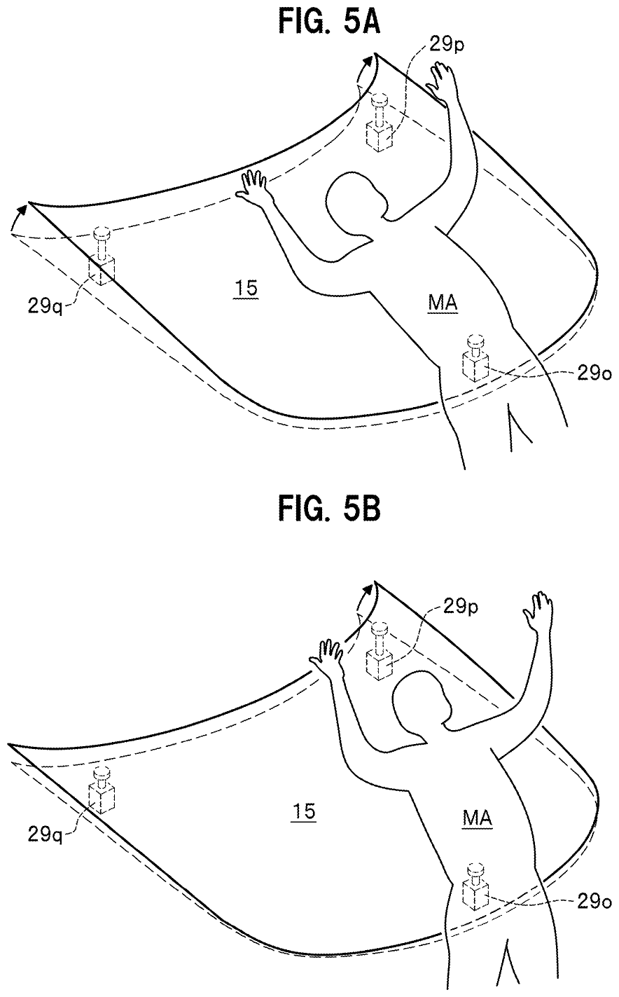

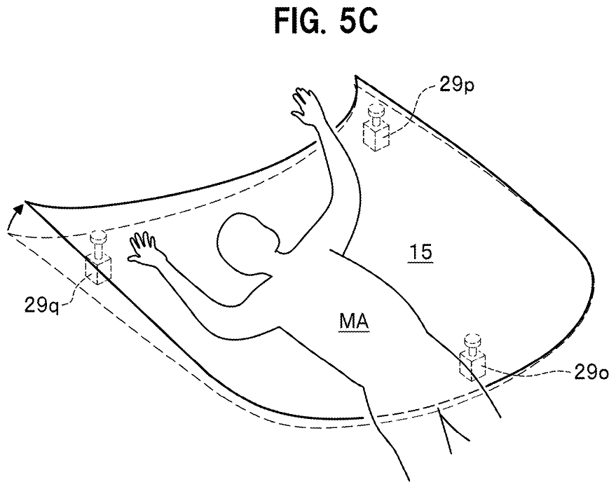

FIG. 5A to FIG. 5C are each an explanatory diagram illustrating operations of a pedestrian protection system 11 according to a variation of the present invention.

The hood pop-up device 29 may be structured, in order to support three corners (three points), namely, one at a central portion on a front side and two at right and left side corner portions on a rear side, of the substantially square-shaped bonnet hood 15 from below in a freely advancing and retracting manner as illustrated in FIG. 5A to FIG. 5C, as a hood pop-up device 29 of three-point support type that includes a CF actuator 29o, a RR actuator 29p, and a LR actuator 29q disposed at respective appropriate positions near the three corners.

The pedestrian protection system 11 including the above-described hood pop-up device 29 of three-point support type can be made to work similarly to the pedestrian protection system 11 including the above-described hood pop-up device 29 of four-point support type.

### DESCRIPTION OF REFERENCE CHARACTERS

11 pedestrian protection system
13 pedestrian protection device
15 bonnet hood
29 hood pop-up device
31 electromagnetic damper (variable damper)
41 information acquisition part
43 collision prediction part
45 drive control part
CA car of interest
MA pedestrian

1. A pedestrian protection system of a vehicle, comprising:
a hood pop-up device that drives a bonnet hood of the vehicle such that a position of the bonnet hood is popped up;
an information acquisition part configured to acquire target object information containing information on one or more pedestrians present in a travel direction of the vehicle;
a collision prediction part configured to determine a pedestrian who is predicted to collide with the vehicle, based on the target object information acquired by the information acquisition part; and
a drive control part configured to control driving of the hood pop-up device such that the bonnet hood is positioned to cushion impact on a head of the pedestrian determined by the collision prediction part,
wherein the bonnet hood is positioned on a slant with respect to a right and left direction of the vehicle.

2. The pedestrian protection system according to claim 1, further comprising a variable damper that drives the vehicle such that a position of the vehicle is changed up, down, right, or left,
wherein the drive control part is configured to control driving of the variable damper such that the vehicle is positioned to cushion impact on the head of the pedestrian determined by the collision prediction part.

3. The pedestrian protection system according to claim 1,
wherein the collision prediction part comprises:
a physical constitution estimate part configured to estimate a physical constitution of the pedestrian determined by the collision prediction part; and
a head collision site estimate part configured to estimate a site of the head of the pedestrian determined by the collision prediction part, and
wherein the drive control part is configured to control driving of the hood pop-up device such that the bonnet hood is positioned to cushion impact on the head of the determined pedestrian, based on the estimated results of the physical constitution of the pedestrian determined by the physical constitution estimate part and the head site of the pedestrian determined by the head collision site estimate part.

4. The pedestrian protection system according to claim 2,
wherein the collision prediction part comprises:
a physical constitution estimate part part configured to estimate a physical constitution of the pedestrian determined by the collision prediction part; and
a head collision site estimate part part configured to estimate a site of the head of the pedestrian determined by the collision prediction part, and
wherein the drive control part is configured to control driving of the variable damper such that the vehicle is positioned to cushion impact on the head of the determined pedestrian, based on the estimated results of the physical constitution of the pedestrian determined by the physical constitution estimate part and the head site of the pedestrian determined by the head collision site estimate part.
